(19) United States
(12) Patent Application Publication
(10) Pub. No.: US 2008/0088810 A1
(43) Pub. Date: Apr. 17, 2008

(54) EUV exposure apparatus for in-situ exposing of substrate and cleaning of optical element included apparatus and method of cleaning optical element included in apparatus

(75) Inventors: Sung-min Huh, Yongin-si (KR); Dong-gun Lee, Hwaseong-si (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 11/820,468

(22) Filed: Jun. 19, 2007

(30) Foreign Application Priority Data
Oct. 11, 2006 (KR) 10-2006-0098866

(51) Int. Cl. G03B 27/54

(52) U.S. Cl. 355/30

(57) ABSTRACT

Provided are an extreme ultraviolet (EUV) exposure apparatus and a method of cleaning optical elements included in the exposure apparatus. The EUV exposure apparatus includes: a light source system generating an exposure beam that comprises an EUV beam during exposure of a substrate and generating a cleaning beam having a longer wavelength than the exposure beam during cleaning of an optical element; an optical system adjusting and patterning the EUV beam and the cleaning beam generated by the light source system; a chamber accommodating the light source system and the optical system; and a molecular oxygen supply unit in communication with the chamber.

### CROSS-REFERENCE TO RELATED PATENT APPLICATION

This application claims priority under 35 U.S.C. 119 to Korean Patent Application No. 10-2006-0098866 filed on Oct. 11, 2006, in the Korean Intellectual Property Office, the disclosure of which is incorporated herein in its entirety by reference.

### BACKGROUND OF THE INVENTION

1. Field of the Invention

Embodiments of the present invention relate to an exposure apparatus and a method of cleaning an optical element included in the exposure apparatus, and more particularly, to an extreme ultraviolet (EUV) exposure apparatus capable of in-situ exposing of a substrate and cleaning of an optical element included in the EUV exposure apparatus and a method of cleaning the optical element included in the EUV exposure apparatus.

2. Description of the Related Art

An exposure apparatus projects an image of a pattern onto a substrate. More specifically, the exposure apparatus irradiates exposure light onto a photomask and transfers a pattern of the photomask to the substrate.

In general, the wavelength of exposure light is decreased in accordance with a decrease in the size of patterns to be transcribed onto substrates, and thus extreme ultraviolet (EUV) radiation having a wavelength of 13.5 nm is now being more widely employed for such a purpose. However, an exposure apparatus using such short-wavelength radiation is sensitive to the presence of contaminant particles. For example, contaminants such as hydrocarbon may be introduced into an exposure apparatus or separated from components and parts thereof irradiated with EUV radiation. The hydrocarbon is then decomposed into carbons by the EUV radiation and absorbed onto an optical element, thus resulting in contamination of the surface of the optical element. Contamination of the surface of the optical element results in a decrease in reflectance of the optical element. It is known that a carbon layer having a thickness of 1.5 nm absorbed onto an optical element causes a 2% decrease in reflectance of the optical element. Such a decrease in reflectance may cause a fatal error in a pattern to be transcribed onto a substrate.

### SUMMARY OF THE INVENTION

The present invention provides an extreme ultraviolet (EUV) apparatus capable of effectively eliminating contaminants absorbed onto the surface of an optical element and a method of cleaning the optical element included in the apparatus.

According to an aspect, there is provided an EUV exposure apparatus including a light source system, an optical system, a chamber, and a molecular oxygen-supplying unit. The light source system generates an exposure beam that is an EUV beam during exposure of a substrate and generates a cleaning beam having a longer wavelength than the exposure beam during cleaning of an optical element. The optical system adjusts and patterns the exposure beam and the cleaning beam generated by the light source system. The light source system and the optical system are accommodated within a chamber. The molecular oxygen-supply unit is in communication with the chamber.

The light source system can comprise a light source generating both the exposure beam and the cleaning beam, an exposure beam filter selectively transmitting the exposure beam, and a cleaning beam filter selectively transmitting the cleaning beam.

The light source system can comprise an exposure light source generating the exposure beam and a cleaning light source generating the cleaning beam.

The cleaning beam can comprise a vacuum UV (VUV) beam.

The optical system can comprise a plurality of multi-thin-layer mirrors.

Each of the multi-thin-layer mirrors can comprise a Molybdenum (Mo)-silicon (Si) multilayer structure.

The optical system can comprise an illuminating optical system delivering light generated by the light source system, a mask system patterning the light received from the illuminating optical system, and a projecting optical system delivering light reflected by the mask system to a substrate system.

According to another aspect, there is provided a method of cleaning optical elements included in an EUV exposure apparatus, the method including: generating an exposure beam comprising an EUV beam in a light source system, delivering the exposure beam to a substrate system through an optical system including the optical elements and exposing a substrate using the EUV beam; and generating a cleaning beam having a longer wavelength region than the exposure beam in the light source system before or after the exposing of the substrate, supplying molecular oxygen to the optical system, delivering the cleaning beam along the same path as the exposure beam, and cleaning the optical elements included in the optical system.

The generating of the exposure beam in the light source system can comprise: selectively filtering the exposure beam from a light source in the light source system generating both the exposure beam and the cleaning beam, wherein the generating of the cleaning beam in the light source system comprises filtering the cleaning beam from the light source.

The light source system can comprise an exposure light source generating the exposure beam and a cleaning light source generating the cleaning beam.

The cleaning beam can comprise a vacuum UV (VUV) beam.

The optical system can comprise a plurality of multi-thin-layer mirrors.

Each of the multi-thin-layer mirrors can comprise a Molybdenum (Mo)-silicon (Si) multilayer structure.

The optical system can comprises an illuminating optical system delivering light generated by the light source system, a mask system patterning the light received from the illuminating optical system, and a projecting optical system delivering light reflected by the mask system to a substrate system.

### BRIEF DESCRIPTION OF THE DRAWINGS

The above and other features and advantages of the embodiments of the present specification will become more apparent by describing in detail exemplary embodiments thereof with reference to the attached drawings in which:

FIGS. 1A and 1B are schematic diagrams respectively illustrating an extreme ultraviolet (EUV) exposure apparatus used for explaining methods of exposing a substrate and cleaning an optical element using the EUV apparatus according to embodiments of the present invention;

FIGS. 2A and 2B are cross-sectional views respectively illustrating the states of an optical element subjected to EUV exposure and cleaning;

FIG. 3 is a graph illustrating reflectance with respect to wavelength of an optical element included in an EUV exposure apparatus according to an embodiment of the present invention;

FIG. 4 is a schematic diagram of an EUV exposure apparatus according to another embodiment of the present invention and used for explaining methods of exposing a substrate and cleaning an optical element using the EUV apparatus according to another embodiment of the present invention; and

FIG. 5 a graph illustrating thicknesses of an oxide layer and a carbon layer formed on an optical element subjected to EUV and vacuum UV (VUV) exposure, which are measured according to time.

### DETAILED DESCRIPTION OF EMBODIMENTS OF THE INVENTION

Embodiments of the present invention will now be described more fully with reference to the accompanying drawings, in which exemplary embodiments of the invention are shown. The invention may, however, be embodied in many different forms and should not be construed as being limited to the embodiments set forth herein. Like reference numerals in the drawings denote like elements, and thus their description will be omitted.

### Embodiment 1

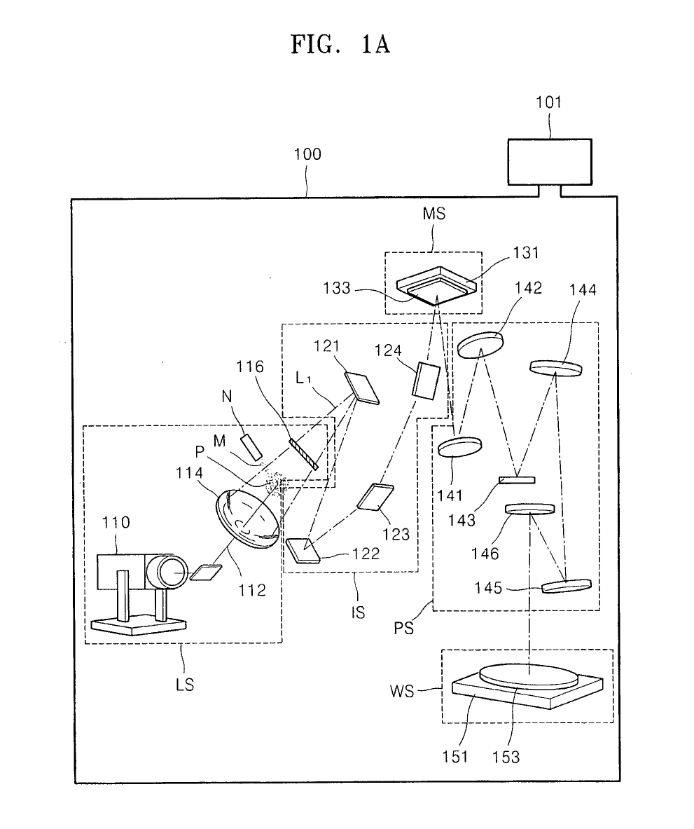

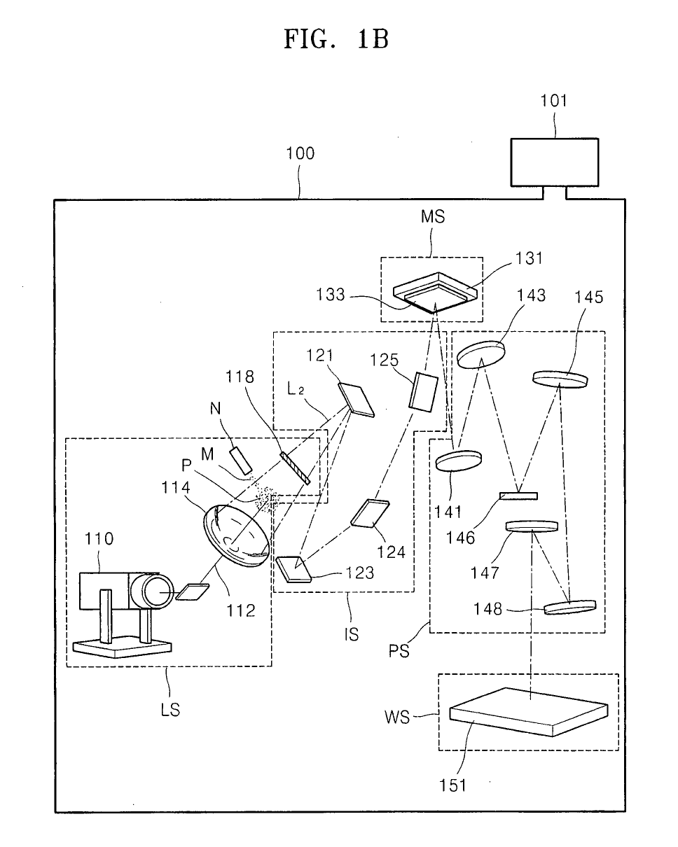

FIGS. 1A and 1B are schematic diagrams respectively illustrating an extreme ultraviolet (EUV) exposure apparatus used for explaining methods of exposing a substrate and cleaning an optical element using the EUV apparatus according to embodiments of the present invention.

The EUV exposure apparatus will now be described with reference to FIGS. 1A and 1B.

The EUV exposure apparatus includes a light source system LS generating an exposure beam L₁ and a cleaning beam L₂, an optical system adjusting and patterning the exposure and cleaning beams L₁ and L₂ generated by the light source system LS, and a substrate system WS. The optical system includes an illuminating optical system IS delivering the exposure and cleaning beams L₁ and L₂ generated by the light source system LS, a mask system MS patterning the exposure and cleaning beams L₁ and L₂ received from the illuminating optical system IS, and a projection optical system PS delivering the exposure and cleaning beams L₁ and L₂ patterned by the mask system MS to the substrate system WS. The light source system LS, the illuminating optical system IS, the mask system MS, the projecting optical system PS, and the substrate system WS are accommodated within a chamber so that they are shielded from the external environment. A vacuum pump (not shown) and molecular oxygen supply unit 101 may be connected to the chamber 100.

The optical system includes a plurality of optical elements 121 through 124, 133, and 141 through 146 that are reflecting elements, i.e., mirrors. Each mirror may include a plurality of thin layers. More specifically, the illuminating optical system IS includes mirrors 121 through 124 for delivering the exposure and cleaning beams L₁ and L₂ generated by the light source system LS. The mask system MS includes a mask 133 that is formed on a mask stage 131 and patterns the exposure and cleaning beams L₁ and L₂ received from the illuminating optical system IS. The projection optical system PS includes mirrors 141 through 146 delivering the exposure and cleaning beams L₁ and L₂ patterned by the mask 133 to the substrate system WS.

The light source system LS generates the exposure beam L₁ during exposure of a substrate 153 as illustrated in FIG. 1A and the cleaning beam L₂ during cleaning of an optical element in FIG. 1B. The exposure beam L₁ is an EUV beam and the cleaning beam L₂ has a longer wavelength than the exposure beam L₁. The exposure beam L₁ may have a wavelength range of 10 to 50 nm. For example, the exposure beam L₁ may have a wavelength of 13.5 nm.

The light source system LS includes a light source P producing the exposure beam L₁ and the cleaning beam L₂, an exposure beam filter 116 selectively transmitting the exposure beam L₁ emitted by the light source P, and a cleaning beam filter 118 selectively transmitting the cleaning beam L₂. During exposure of the substrate 153 or during cleaning of an optical element, the exposure beam L₁ and the cleaning beam L₂ can be easily selected by switching between the exposure beam filter 116 and the cleaning beam filter 118.

The cleaning beam L₂ may be a vacuum UV (VUV) beam having a wavelength of 100 to 300 nm, for example, 172 nm. The light source system LS includes a light source P generating the EUV and VUV beams L₁ and L₂. The light source P may be laser plasma or discharge plasma, and preferably, laser plasma.

The light source P may comprise high temperature laser plasma generated by irradiating a laser beam 112 having a high intensity pulse onto a target material M emitted from a nozzle N, such as inert gas xenon (Xe). The laser plasma is used to generate both the exposure and cleaning beams L₁ and L₂. The laser beam 112 is emitted from a laser device 110. The exposure beam filter 116 selectively transmitting the exposure beam L₁ is installed in the path of the light source P during exposure of the substrate 153 (FIG. 1A). The cleaning beam filter 118 selectively transmitting the cleaning beam L₂ is installed in the path of the light source P during cleaning of an optical element (FIG. 1B). For example, the exposure beam filter 116 and the cleaning beam filter 118 may be a zirconium (Zr) filter and a calcium fluoride (CaF₂) filter, respectively.

The exposure and cleaning beams L₁ and L₂ generated by the light source system LS are delivered to the substrate system WS along the same path.

A method of exposing a substrate and cleaning an optical element using an EUV exposure apparatus according to an embodiment of the present invention will now be described with reference to FIGS. 1A and 1B.

Referring to FIG. 1A, the substrate 153 is mounted on a substrate stage 151 and the mask 133 is installed on the mask stage 131. Then, the vacuum pump connected to the chamber 100 operates to create a vacuum atmosphere within the chamber.

The light source system LS generates the exposure beam L₁ that is an EUV beam. For example, the light source P may be laser plasma. In this case, the laser device 110 irradiates a laser beam 112 having a high intensity pulse onto target material M emitted from the nozzle N to generate high temperature plasma P. The exposure beam L₁ is thus emitted by the light source P. Another beam having a different wavelength range than the exposure beam L₁ may also be emitted from the light source P. The emitted beams are condensed by a condenser mirror 114, which is disposed behind the light source P, in front of the light source P. The exposure beam filter 116, that is a EUV filter, is disposed in front of the light source P and selectively transmits the exposure beam L₁. In this manner, the light source system LS emits the exposure beam L₁ that is an EUV beam. The exposure beam filter 116 may be a Zr filter.

The emitted exposure beam L₁ is incident into the optical system. More specifically, the exposure beam L₁ is incident into the illuminating optical system IS and is adjusted by the plurality of optical elements 121 through 124 in the illuminating optical system IS so as to have optimal uniformity and intensity distribution before being delivered to the mask system MS. The mask 133 in the mask system MS selectively reflects and patterns the exposure beam L₁ optimally adjusted by the optical elements 121 through 124. The patterned exposure beam L₁ is then incident into the projecting optical system PS and is projected by the plurality of optical elements 141 through 146 onto the substrate 153. The substrate 153 is then exposed to the exposure beam L₁, thus causing a pattern to be transferred onto the substrate 153.

During exposure of the substrate 153, contaminant particles such as hydrocarbon may be created in the chamber 100 or introduced thereinto. More specifically, the hydrocarbon may be fed into the chamber 100 or separated from components and parts of the EUV exposure apparatus irradiated with EUV. The hydrocarbon is then decomposed into carbons by EUV irradiation and absorbed onto the optical elements 121 through 124, 133, and 141 through 146 to form a carbon layer. Formation of the carbon layer results in a significant decrease in reflectance of the optical elements 121 through 124, 133, and 141 through 146.

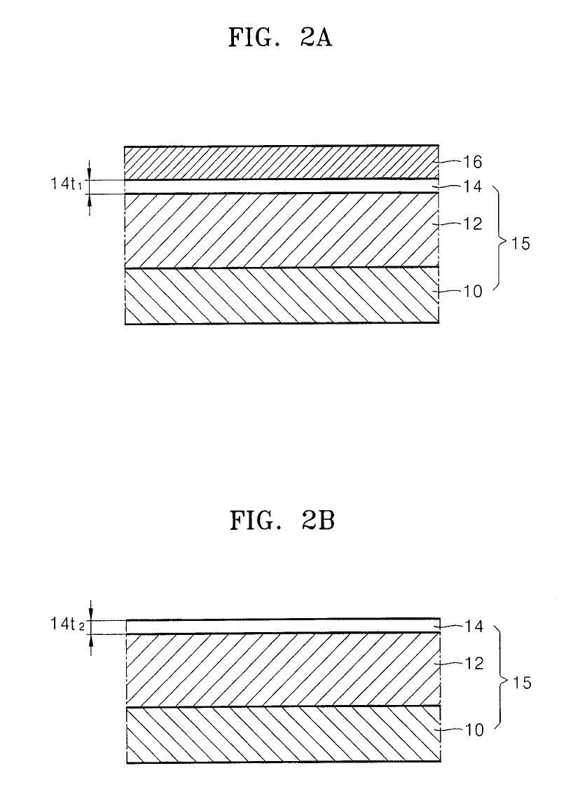

FIG. 2A is a cross-sectional view illustrating the state of an optical element 15 subjected to EUV exposure.

Referring to FIG. 2, a carbon layer 16 is absorbed onto the optical element 15. The optical element 15 may be, for example, a portion of one of the optical elements 121 through 124, 133, and 141 through 146 described with reference to FIG. 1A.

In this embodiment, the optical element 15 is a multi-thin-layered mirror and includes an optical substrate 10, a multilayer structure 12 consisting of a plurality of alternating first and second layers with a large difference in optical characteristics formed on the optical substrate 10, and a native oxide layer 14 formed on the multilayer structure 12 to a predetermined thickness 14t₁. The multilayer structure 12 reflects EUV radiation from an interface between the first and second layers due to the optical difference between the first and second layers. In one example, the first and second layers can be formed of molybdenum (Mo) and silicon (Si), respectively. That is, the multilayer structure 12 consists of a plurality of molybdenum (Mo) and silicon (Si) layers.

The thickness 14t₁ of the native oxide layer 14 is generally not considered in an optical system. In general, when the first and second layers are formed of Mo and Si, respectively, the native oxide layer formed on a Si surface generally has higher stability than that on a Mo surface. Thus, the Si layer may be formed on the uppermost surface of the multilayer structure 12 so as to create a silicon oxide layer on the multilayer structure 12.

Referring to FIG. 1A, the degree of absorption of the carbon layer 16 in FIG. 2A onto the optical element 15 irradiated with EUV radiation, i.e., the thickness of the carbon layer 16, is proportional to the intensity of the exposure beam L₁ irradiated onto the optical elements 121 through 124, 133, and 141 through 146. The intensity of the exposure beam L₁ becomes progressively lower as the exposure beam L₁ passes through the optical elements 121 through 124, 133, and 141 through 146. That is, carbon layers formed on the optical elements 121 through 124, 133, and 141 through 146 become progressively thinner in accordance with the order in which the optical elements 121 through 124, 133, and 141 through 146 are irradiated by the exposure beam L₁.

A method of cleaning the optical elements 121 through 124, 133, and 141 through 146 by removing the carbon layers on the optical elements 121 through 124, 133, and 141 through 146 will now be described with reference to FIG. 1B. Referring to FIG. 1B, first, an exposed substrate 153 is unloaded from the chamber 100.

Then, a cleaning beam L₂ having a longer wavelength than the exposure beam L₁ is generated by the light source system LS. The cleaning beam L₂ is selectively filtered out of the light source P generating both the exposure beam L₁ and the cleaning beam L₂. More specifically, the laser device 110 irradiates a laser beam 112 having a high intensity pulse onto target material M emitted from the nozzle N to generate high temperature plasma. In this case, the cleaning beam L₂ is emitted from the light source P together with the exposure beam L₁. The emitted exposure and cleaning beams L₁ and L₂ are condensed in front of the light source P by the condenser mirror 114 disposed to the rear of the light source P. The cleaning beam filter 118 is installed in front of the light source P and selectively transmits the cleaning beam L₂. In this manner, the light source system LS emits the cleaning beam L₂.

Molecular oxygen is supplied from the molecular oxygen supply unit 101 into the chamber 100 before, after, or simultaneously with emission of the cleaning beam L₂ from the light source system LS. To this end, the molecular oxygen supply unit 101 can supply air into the chamber 100. In this manner, a molecular oxygen atmosphere is created within the chamber 100, i.e., within the illuminating optical system IS, the mask system MS, and the projecting optical system PS.

The cleaning beam L₂ is delivered to the substrate system WS along the same path as the exposure beam L₁. More specifically, the cleaning beam L₂ is incident into the illuminating optical system IS at the same position as the exposure beam L₁, is sequentially reflected by the optical elements 121 through 124 included in the illuminating optical system IS, is reflected from the mask 133, and is sequentially reflected by the optical elements 141 through 146 in the projecting optical system PS.

The cleaning beam L₂ incident on the optical elements 121 through 124, 133, and 141 through 146 activates molecular oxygen supplied near the optical elements 121 through 124, 133, and 141 through 146. The activated oxygen, i.e., oxygen radical or ozone, may oxidize the carbon layers present on the optical elements 121 through 124, 133, and 141 through 146, thus removing the carbon layers from the top surfaces of the optical elements 121 through 124, 133, and 141 through 146 as illustrated in FIG. 2B. FIG. 2B is a cross-sectional view illustrating the state of an optical element 15 subjected to EUV cleaning.

If the activated oxygen continues to be supplied onto the optical elements 121 through 124, 133, and 141 through 146 even after removing the carbon layers, the surfaces of the optical elements 121 through 124, 133, and 141 through 146 may be oxidized, thus resulting in a decrease in reflectance of the optical elements 121 through 124, 133, and 141 through 146. Further, because the oxidation of the optical elements 121 through 124, 133, and 141 through 146 is an irreversible reaction, accumulated oxidation of the surface of the optical elements 121 through 124, 133, and 141 through 146 may result in the need for replacement of the optical elements 121 through 124, 133, and 141 through 146 by other new optical elements.

However, the number of secondary electrons generated by the cleaning beam L₂ with a longer wavelength than the exposure beam L₁ is significantly smaller than the number of electrons generated when the exposure beam L₁ is used as the cleaning beam L₂. Thus, use of the cleaning beam L₂ results in a slight oxidation of the surfaces of the optical elements 121 through 124, 133, and 141 through 146. That is, the thickness 14t₁ of the native oxide layer 14 in FIG. 2A measured before removing the carbon layer 16 is almost equal to the thickness 14t₂ of the native oxide layer 14 in FIG. 2B exposed after removing the carbon layer 16. Thus, the cleaning beam L₂ having a longer wavelength region than the exposure beam L₁ can effectively remove the carbon layers without significantly oxidizing the surfaces of the underlying optical elements 121 through 124, 133, and 141 through 146.

The degree of removal of the carbon layers due to irradiation of the cleaning beam L₂ is proportional to the intensity of the cleaning beam L₂ irradiated onto the optical elements 121 through 124, 133, and 141 through 146. Since the cleaning beam L₂ is delivered to the substrate system WS through the same optical path as the exposure beam L₁, the intensity of the cleaning beam L₁ may become progressively lower as the cleaning beam L₂ passes through the optical elements 121 through 124, 133, and 141 through 146, as with the exposure beam L₁. That is, the degree of removal of the carbon layers decreases in accordance with the order in which the optical elements 121 through 124, 133, and 141 through 146 are irradiated by the cleaning beam L₂. As described above, because the carbon layers on the optical elements 121 through 124, 133, and 141 through 146 have thicknesses that progressively decrease in the order in which the optical elements 121 through 124, 133, and 141 through 146 are irradiated with the exposure beam L₁, the cleaning beam L₂ can suitably remove only the carbon layers without substantially oxidizing the surfaces of the underlying optical elements 121 through 124, 133, and 141 through 146. Conversely, if a cleaning beam having an equal or similar intensity is irradiated onto the optical elements 121 through 124, 133, and 141 through 146 regardless of the thicknesses of carbon layers formed thereon, the cleaning beam needs to be irradiated until the thickest carbon layer is completely removed. Thus, the surfaces of some optical elements with thin carbon layers formed thereon may suffer from over-oxidation due to overetching of the thin carbon layers.

For example, the cleaning beam L₂ may be a VUV beam. In this case, the cleaning beam filter 118 may be a CaF₂ filter. VUV radiation is proven to create a greater amount of activated oxygen than EUV radiation, thus allowing more effective removal of carbon layers. Another advantage of VUV radiation, which has lower energy than EUV radiation, is that the number of secondary electrons generated on the surfaces of the optical elements 121 through 124, 133, and 141 through 146 can be reduced, thus resulting in a low degree of oxidation of the surface of the optical elements 121 through 124, 133, and 141 through 146.

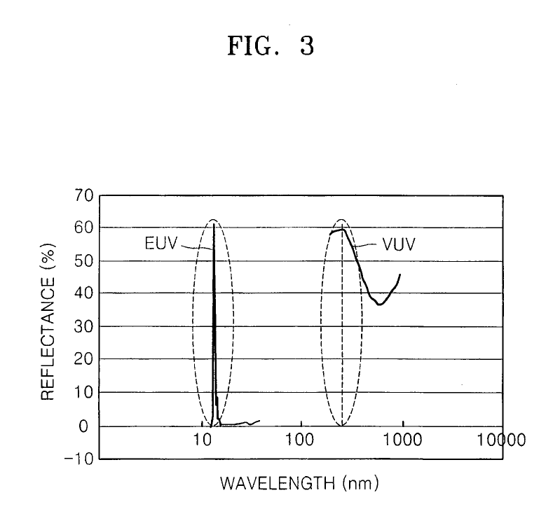

FIG. 3 is a graph illustrating reflectance of an optical element with respect to wavelength included in an EUV exposure apparatus according to an embodiment of the present invention.

Referring to FIG. 3, the optical element in the EUV exposure apparatus reflects an EUV beam as well as a VUV beam. The EUV beam has similar reflectance to the VUV beam.

Thus, when a VUV beam is used as the cleaning beam L₂ in FIG. 1B, the VUV beam is sequentially reflected by the optical elements 121 through 124, 133, and 141 through 146 through the same optical path with the same reflectance as the exposure beam L₁ in FIG. 1B that is an EUV beam, thus effectively removing carbon layers formed on the optical elements 121 through 124, 133, and 141 through 146.

### Embodiment 2

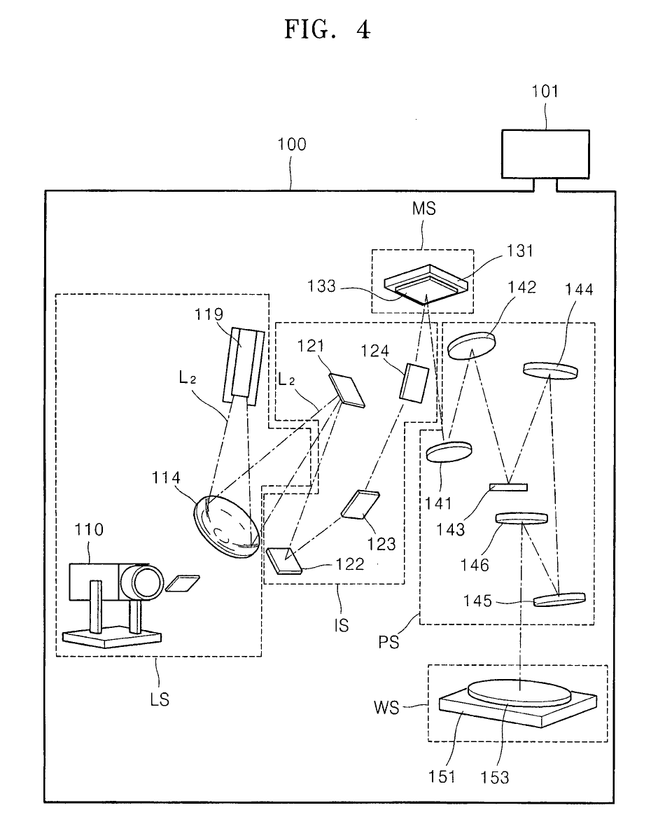

FIG. 4 is a schematic diagram illustrating an EUV exposure apparatus according to another embodiment of the present invention and used for explaining methods of exposing a substrate and cleaning an optical element using the EUV apparatus according to another embodiment of the present invention. The method of exposing a substrate according to the current embodiment of the present invention is performed in the same manner as described with reference to FIG. 1A. The method of cleaning an optical element according to the current embodiment of the present invention is performed in the same manner as described with reference to FIG. 1B, except as described below.

Referring to FIG. 4, a light source system LS includes a separate cleaning light source 119 generating a cleaning beam L₂ in addition to the light source P in FIG. 1A generating the exposure beam L₁ in FIG. 1A. The cleaning beam L₂ may be a VUV beam. The cleaning light source 119 may be an Xe excimer lamp assembly. The cleaning beam L₂ generated by the cleaning light source 119 is delivered to the substrate system WS along the same path as the exposure beam L₁.

As in the embodiment described above with reference to FIG. 1A, the light source system LS includes the light source P in FIG. 1A producing the exposure beam L₁ and a beam having a different wavelength than the exposure beam L₁ and the exposure beam filter 116 in FIG. 1A selectively transmitting the exposure beam L₁ emitted by the light source P.

### EXPERIMENTAL EXAMPLE

### Effect of Cleaning Optical Element Due to VUV Irradiation in Molecular Oxygen Atmosphere

An optical element was prepared. The optical element was a mirror including a multilayer structure consisting of a plurality of alternating Si and Mo layers and a native oxide layer formed on the multilayer structure. The thickness of the native oxide layer was measured and then an EUV beam having a wavelength of 13.5 nm was irradiated on the mirror for 60 minutes. Thereafter, the thicknesses of the native oxide layer and a carbon layer absorbed onto the native oxide layer were measured. Thereafter a 172 nm VUV beam was irradiated onto the mirror in an air ambient for 15 minutes. While the VUV beam was irradiated, the thicknesses of the native oxide layer and the carbon layer were measured using ellipsometry.

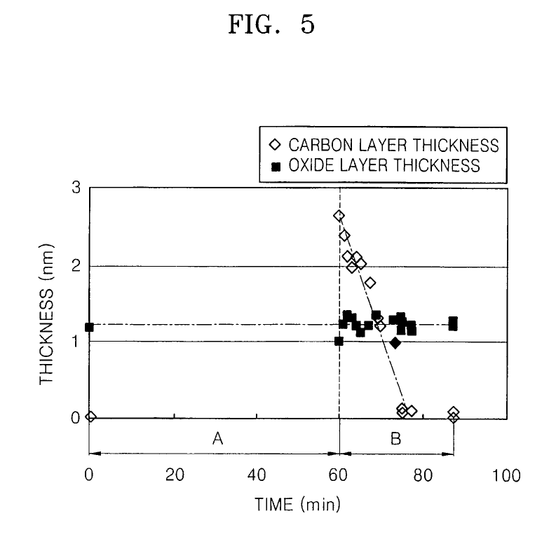

FIG. 5 a graph illustrating the thicknesses of the native oxide layer and the carbon layer measured with respect to exposure time.

Referring to FIG. 5, a carbon layer having a thickness of about 2.7 nm was formed on the mirror after finishing the EUV irradiation (A). The carbon layer was completely removed by irradiating VUV radiation for 15 minutes in an air ambient containing molecular oxygen. Despite the removal of the carbon layer, there was little variation in the thicknesses of the native oxide layer measured before the EUV irradiation (A) and after the VUV irradiation (B). Thus, by irradiating the VUV beam in the molecular oxygen atmosphere, the carbon layer can be effectively removed without the need to increase the thickness of the native oxide layer.

As described above, according to the present invention, a light source system generates an EUV beam during exposure of a substrate and a cleaning beam having a longer wavelength than the EUV beam during cleaning of an optical element so that the EUV beam and the cleaning beam can be delivered to a substrate system through the same path. Thus, the present invention allows in-situ exposure of the substrate and cleaning of the optical element. Furthermore, use of the cleaning beam having a longer wavelength than the EUV beam allows effective removal of a carbon layer formed on the optical element without significant oxidation of the surface of the optical element.

While embodiments of the present invention have been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. An extreme ultraviolet (EUV) exposure apparatus comprising:
a light source system generating an exposure beam that comprises an EUV beam during exposure of a substrate and generating a cleaning beam having a longer wavelength than the EUV beam during cleaning of an optical element;
an optical system adjusting and patterning the exposure beam and the cleaning beam generated by the light source system;
a chamber accommodating the light source system and the optical system; and
a molecular oxygen supply unit in communication with the chamber.

2. The apparatus of claim 1, wherein the light source system comprises a light source generating both the exposure beam and the cleaning beam, an exposure beam filter selectively transmitting the exposure beam, and a cleaning beam filter selectively transmitting the cleaning beam.

3. The apparatus of claim 1, wherein the light source system comprises an exposure light source generating the exposure beam and a cleaning light source generating the cleaning beam.

4. The apparatus of claim 1, wherein the cleaning beam comprises a vacuum UV (VUV) beam.

5. The apparatus of claim 1, wherein the optical system comprises a plurality of multi-thin-layer mirrors.

6. The apparatus of claim 5, wherein each of the multi-thin-layer mirrors comprises a Molybdenum (Mo)-silicon (Si) multilayer structure.

7. The apparatus of claim 1, wherein the optical system comprises an illuminating optical system delivering light generated by the light source system, a mask system patterning the light received from the illuminating optical system, and a projecting optical system delivering light reflected by the mask system to a substrate system.

8. A method of cleaning optical elements included in an extreme ultraviolet (EUV) exposure apparatus, the method comprising:
generating an exposure beam comprising an EUV beam in a light source system, delivering the exposure beam to a substrate system through an optical system comprising the optical elements, and exposing a substrate using the EUV beam; and
generating a cleaning beam having a longer wavelength than the exposure beam in the light source system before or after the exposing of the substrate, supplying molecular oxygen to the optical system, delivering the cleaning beam along the same path as the exposure beam, and cleaning the optical elements included in the optical system.

9. The method of claim 8, wherein the generating of the exposure beam in the light source system comprises selectively filtering the exposure beam from a light source in the light source system generating both the exposure beam and the cleaning beam, and
wherein the generating of the cleaning beam in the light source system comprises filtering the cleaning beam from the light source.

10. The method of claim 8, wherein the light source system comprises an exposure light source generating the exposure beam and a cleaning light source generating the cleaning beam.

11. The method of claim 8, wherein the cleaning beam is a vacuum UV (VUV) beam.

12. The method of claim 8, wherein the optical system comprises a plurality of multi-thin-layer mirrors.

13. The method of claim 12, wherein each of the multi-thin-layer mirrors comprises a Molybdenum (Mo)-silicon (Si) multilayer structure.

14. The method of claim 8, wherein the optical system comprises an illuminating optical system delivering light generated by the light source system, a mask system patterning the light received from the illuminating optical system, and a projecting optical system delivering light reflected by the mask system to a substrate system.
